(19) United States
(12) Patent Application Publication
(10) Pub. No.: US 2023/0104366 A1
(43) Pub. Date: Apr. 6, 2023

(54) ABNORMALITY DETERMINATION DEVICE

(71) Applicant: Fanuc Corporation, Minamitsuru-gun, Yamanashi (JP)

(72) Inventor: Keita Hada, Minamitsuru-gun, Yamanashi (JP)

(73) Assignee: Fanuc Corporation, Minamitsuru-gun, Yamanashi (JP)

(21) Appl. No.: 17/910,031

(22) PCT Filed: Mar. 11, 2021
(86) PCT No.: PCT/JP2021/009903

§ 371 Date: Sep. 8, 2022

(30) Foreign Application Priority Data
Mar. 17, 2020 (JP) 2020-046633

(51) Int. Cl. G05B 23/02

(52) U.S. Cl. CPC G05B 23/0235; G05B 23/0254

(57) ABSTRACT

Provided is an abnormality determination device capable of correctly determining an abnormality even when data having different environmental temperatures is mixedly present. This abnormality determination device includes: a normal data storage unit; a diagnostic data storage unit; a compensation value derivation unit that obtains a feature amount of normal data at each environmental temperature and derives, as a compensation value, statistics obtained from the feature amount; a compensation value interpolation unit that uses at least two compensation values for the environmental temperature to obtain, by interpolation, the compensation value of the environmental temperature when diagnostic data is acquired; a normal data compensation unit that compensates the feature amount of the normal data using the compensation value; a learning unit that learns, as learning data, the compensated feature amount of the normal data and constructs a learning model; a diagnostic data compensation unit that compensates a feature amount of the diagnostic data using the compensation value; and a machine abnormality determination unit that determines whether or not the diagnostic data is normal on the basis of the degree of deviation between the compensated feature amount of the diagnostic data and the learning model.

### CROSS REFERENCE TO RELATED APPLICATIONS

This is the U.S. National Phase application of PCT/JP2021/009903, filed Mar. 11, 2021, which claims priority to Japanese Patent Application No. 2020-046633, filed Mar. 17, 2020, the disclosures of these applications being incorporated herein by reference in their entireties for all purposes.

### FIELD OF THE INVENTION

The present invention relates to an abnormality determination device.

### BACKGROUND OF THE INVENTION

There is known a device that determines abnormality of an industrial apparatus such as a machine tool. For example, PTL 1 describes a device that calculates, by a machine learning method, a degree of divergence between data acquired when an industrial apparatus normally operates, and data acquired from an industrial apparatus that is a target of diagnosis, and determines abnormality, based on the obtained degree of divergence.

### PATENT LITERATURE

[PTL 1] Japanese Patent No. 6451662

### SUMMARY OF THE INVENTION

FIG. 3A to FIG. 3D illustrate examples of torque command waveforms acquired from a machine. FIG. 3A to FIG. 3D illustrate torque waveforms in cases where an identical torque command is applied to an electric motor that drives a certain shaft of the machine. Specifically, FIG. 3A illustrates a torque command waveform 201 in a case where an environmental temperature is low and the machine is normal, FIG. 3B illustrates a torque command waveform 202 in a case where the environmental temperature is low and the machine is abnormal, FIG. 3C illustrates a torque command waveform 203 in a case where the environmental temperature is high and the machine is normal, and FIG. 3D illustrates a torque command waveform 204 in a case where the environmental temperature is high and the machine is abnormal.

Referring to FIG. 3A to FIG. 3D, it can be understood that the torque command waveform 201 at the normal time at the low temperature and the torque command waveform 202 at the abnormal time at the low temperature are distinguishable from features of waveforms (a maximum value, a minimum value, Peak to Peak (P2P), and the like). It can also be understood that the torque command waveform 203 at the normal time at the high temperature and the torque command waveform 204 at the abnormal time at the high temperature are distinguishable from the features of waveforms. In other words, when the environmental temperature is identical between the normal time and the abnormal time, the abnormality of the machine can be determined by calculating the degree of divergence between the torque command waveforms. However, since the torque command waveform 202 at the abnormal time at the low temperature and the torque command waveform 203 at the normal time at the high temperature are similar, a sufficient degree of divergence does not appear between the torque command waveforms, and there is a possibility that the abnormality of the machine cannot be determined.

According to one mode of the present disclosure, an abnormality determination device that determines abnormality of a machine includes a normal data storage unit configured to correlate and store normal data that is data relating to a state of the machine at a time when the machine normally operates, and an environmental temperature of the machine at a time when the normal data is acquired; a diagnosis data storage unit configured to correlate and store diagnosis data that is data relating to the state of the machine at a time of diagnosing the machine, and the environmental temperature of the machine at a time when the diagnosis data is acquired; a compensation value deriving unit configured to calculate a predetermined feature at each of the environmental temperatures in regard to the normal data stored in the normal data storage unit, and derive a statistical quantity obtained from the calculated feature at each of the environmental temperatures, as a compensation value at each of the environmental temperatures; a compensation value interpolation unit configured to calculate, by interpolation, the compensation value in regard to the environmental temperature at a time when the diagnosis data is acquired, by using the compensation values in regard to at least two environmental temperatures with respect to which the normal data is included in the normal data storage unit; a normal data compensation unit configured to compensate the feature of the normal data by using the compensation value at each of the environmental temperatures; a learning unit configured to construct a learning model by performing learning by using the feature of the compensated normal data as training data at a normal time; a diagnosis data compensation unit configured to compensate the feature of the diagnosis data by using the compensation value calculated by the compensation value interpolation unit; and a machine abnormality determination unit configured to determine whether the diagnosis data is normal, based on a degree of divergence between the feature of the compensated diagnosis data and the learning model.

As described above, according to the present embodiment, exact diagnosis can be performed by calculating a compensation value from normal data in accordance with an environmental temperature, and compensating data relating to a state of a machine.

From a detailed description of typical embodiments of the present invention illustrated in the accompanying drawings, the objects, features and advantageous effects of the present invention, and other objects, features and advantageous effects of the invention, will be clearer.

### BRIEF DESCRIPTION OF DRAWINGS

FIG. 1 is a block diagram illustrating a hardware configuration of an abnormality determination device according to an embodiment.

FIG. 2 is a functional block diagram of the abnormality determination device.

FIG. 3A is a view illustrating an example of a torque command waveform as state data at a normal time at a low temperature of a machine.

FIG. 3B is a view illustrating an example of a torque command waveform as state data at an abnormal time at a low temperature of the machine.

FIG. 3C is a view illustrating an example of a torque command waveform as state data at a normal time at a high temperature of the machine.

FIG. 3D is a view illustrating an example of a torque command waveform as state data at an abnormal time at a high temperature of the machine.

FIG. 4 is a view illustrating a first example of interpolation of a compensation value.

FIG. 5 is a view illustrating a second example of the interpolation of the compensation value.

FIG. 6 is a flowchart representing a diagnosis process of a first embodiment.

FIG. 7 is a flowchart representing a diagnosis process of a second embodiment.

FIG. 8 is a flowchart representing a diagnosis process of a third embodiment.

### DETAILED DESCRIPTION OF EMBODIMENTS OF THE INVENTION

Next, embodiments of the present disclosure will be described with reference to the accompanying drawings. In the drawings to be referred to, similar structural parts or functional parts are denoted by the same reference numerals. These drawings use different scales as appropriate to facilitate understanding. The mode illustrated in each drawing is one example for carrying out the present invention, and the present invention is not limited to the modes illustrated in the drawings.

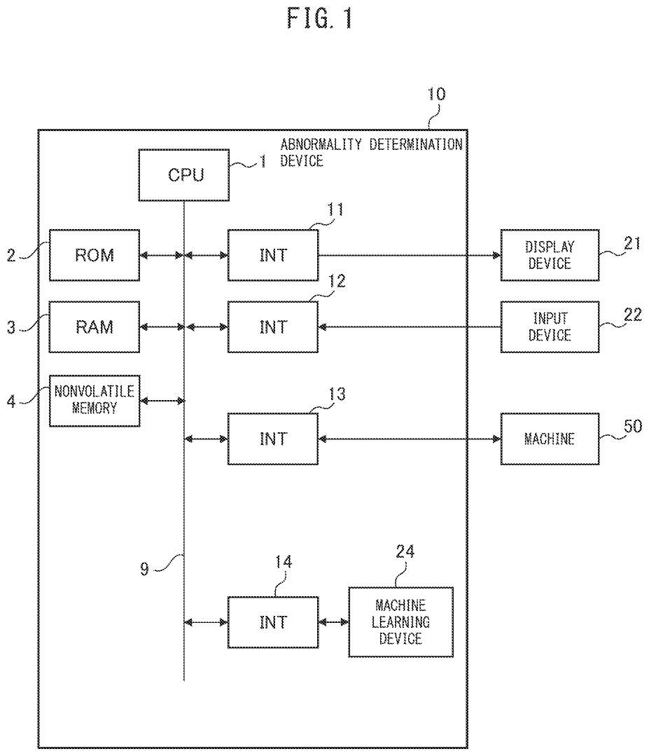

FIG. 1 is a block diagram illustrating a hardware configuration of an abnormality determination device 10 according to an embodiment. As illustrated in FIG. 1, the abnormality determination device 10 includes a configuration in which a CPU 1, a ROM 2, a RAM 3 and a nonvolatile memory (flash memory, HDD, or the like) 4 are interconnected via a bus 9. In addition, a display device (a liquid crystal display, or the like) 21 is connected to the bus 9 via an interface 11, an input device (a keyboard, a mouse, or the like) 22 is connected to the bus 9 via an interface 12, and a machine learning device 24 is connected to the bus 9 via an interface 14. The abnormality determination device 10, display device 21 and input device 22 can be implemented by general personal computers. A machine 50 is connected to the abnormality determination device 10 via an external interface 13. As will be described below in detail, the abnormality determination device 10 acquires data (hereinafter, also referred to as “state data”) relating to the state of the machine 50, and executes abnormality determination of the machine 50.

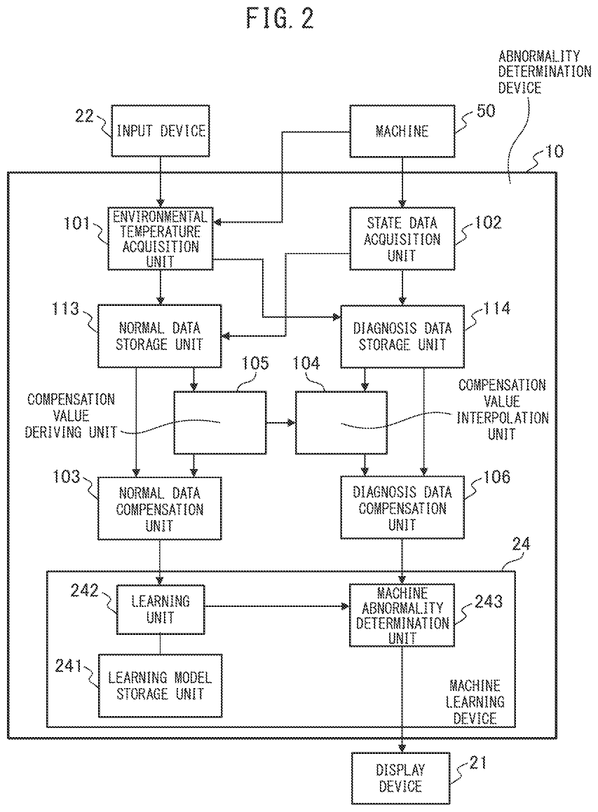

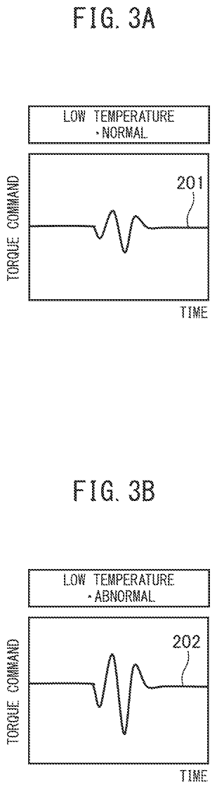

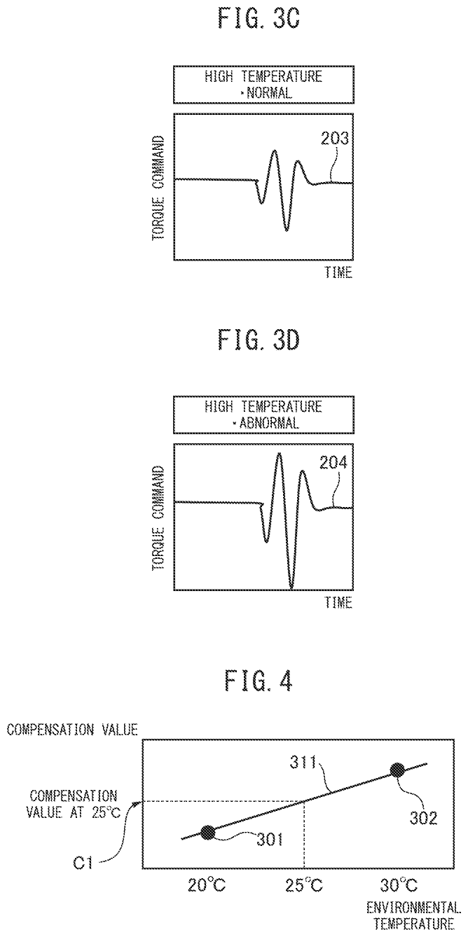

FIG. 2 is a functional block diagram of the abnormality determination device 10. The abnormality determination device 10 includes an environmental temperature acquisition unit 101 that acquires an environmental temperature of the machine 50 directly from the machine 50, or via the input device 22; and a state data acquisition unit 102 that acquires data relating to the state of the machine 50. The abnormality determination device 10 further includes a normal data storage unit 113 that correlates and stores the state data of the machine 50 at a normal operation time, and the environmental temperature of the machine 50 at the time when the state data is acquired; a compensation value deriving unit 105 that calculates a predetermined feature at each of environmental temperatures in regard to the state data stored in the normal data storage unit 113, and derives a statistical quantity calculated from the calculated feature at each of the environmental temperatures, as a compensation value at each environmental temperature; and a normal data compensation unit 103 that compensates the feature of the state data in regard to each environmental temperature, by using the compensation value derived by the compensation value deriving unit 105. Moreover, the abnormality determination device 10 includes a diagnosis data storage unit 114 that correlates and stores the state data at a time of diagnosing the machine 50 and the environmental temperature of the machine 50 at a time when the state data is acquired; a compensation value interpolation unit 104 that calculates, by interpolation, a compensation value at the environmental temperature at a time when the diagnosis data of the machine 50 is acquired, by using the compensation values relating to at least two environmental temperatures with respect to which the state data is included in the normal data storage unit 113; and a diagnosis data compensation unit 106 that compensates the feature of the state data at the time of executing diagnosis, by using the compensation value derived by the compensation value interpolation unit 104.

Besides, the abnormality determination device 10 includes a machine learning device 24. The machine learning device 24 includes a learning unit 242 that constructs a learning model by performing learning by using the feature of the state data compensated by the normal data compensation unit 103 as training data at a normal time; a learning model storage unit 241 that stores the learning model constructed by the learning unit 242; and a machine abnormality determination unit 243 that determines whether the diagnosis data is normal, based on a degree of divergence between the diagnosis data compensated by the diagnosis data compensation unit 106 and the learning model.

The machine 50 includes a machine tool, an industrial robot, and other various machines. As the state data of the machine 50, various data representative of physical states of the machine 50 is included. Here, by way of example, a case is described in which the machine 50 is a machine tool, and the state data is a torque command (torque control) waveform for an electric motor that drives an axis of the machine tool.

In the abnormality determination device 10, the normal data compensation unit 103 compensates the state data in accordance with a predetermined rule by using a compensation value of the state data at each of temperatures. The predetermined rule is, for example, an arithmetic operation of dividing the feature of the state data that is a compensation target by the compensation value in regard to each of environmental temperatures. Thereby, when the state data that is the compensation target is the state data at the normal time, a feature after compensation becomes approximately 1, regardless of the environmental temperature, and a comparison in diagnosis can easily be executed.

The compensation value used in the compensation in the normal data compensation unit 103 is a predetermined statistical quantity calculated by the compensation value deriving unit 105 with respect to the feature calculated from the waveforms of the state data at the normal time at each environmental temperature. The compensation value deriving unit 105 extracts state data at a specific environmental temperature from a state data group that is stored in the normal data storage unit 113 by being correlated with environmental temperature data. A predetermined statistical quantity calculated with respect to the feature of the extracted state data waveform is set as the compensation value at the environmental temperature. As the feature of the waveform, a P2P (Peak to Peak) is used. Note that a maximum value or a minimum value may be used as the feature of the waveform. In the present embodiment, although it is assumed that an average value is used as the predetermined statistical quantity, a median, a mode or the like may be used, or two or more features may be used. By executing a similar operation, if state data at a corresponding environmental temperature exists in the normal data storage unit 113, the compensation value at this environmental temperature can be derived.

By the above-described configuration, the state data at the normal time of the machine 50 can be obtained in regard to each of environmental temperatures. However, in general, the environmental temperature of the machine does not greatly change, and it is difficult to acquire in advance the state data at the normal time in regard to all environmental temperatures, and to accumulate the state data in the normal data storage unit 113. Accordingly, there arises such a problem that a compensation value is not obtained for the environmental temperature with respect to which the state data could not be obtained in advance. As regards this point, the abnormality determination device 10 according to the present embodiment is configured to acquire, in regard to an environmental temperature with respect to which a compensation value has not been obtained, the compensation value by an interpolation operation, based on compensation values at environmental temperatures with respect to which state data have been obtained. In the abnormality determination device 10, the compensation value interpolation unit 104 executes this function.

An interpolation operation of a compensation value by the compensation value interpolation unit 104 is described. By way of example, as illustrated in FIG. 4, it is assumed that compensation values 301 and 302 in regard to two environmental temperatures (here, 20° C. and 30° C.) are acquired in advance by the compensation value deriving unit 105. The compensation value interpolation unit 104 calculates a straight line 311 (relational expression) representing a relation between the environmental temperature and the compensation value, by linear regression using the known compensation values 301 and 302. The compensation value interpolation unit 104 calculates a compensation value Cl at a specific environmental temperature (here, 25° C.) by using the straight line 311.

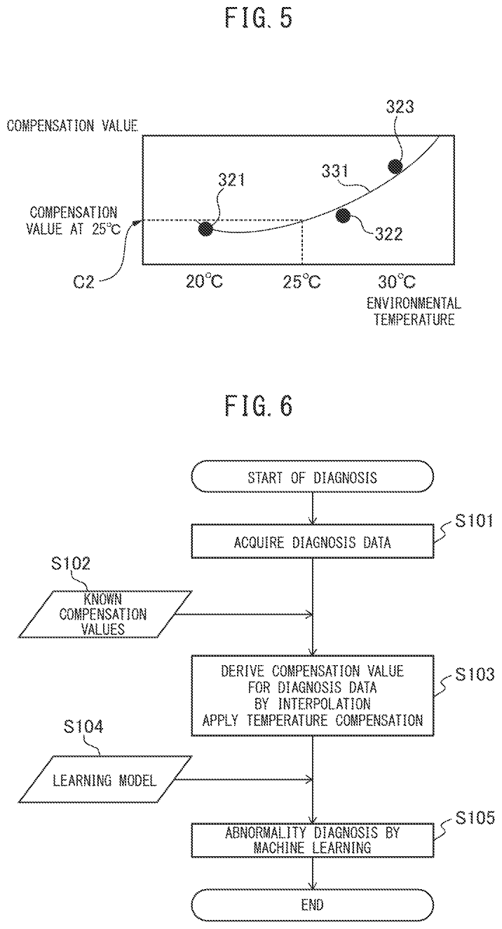

As another example of the interpolation calculation, as illustrated in FIG. 5, a condition is assumed in which known compensation values 321, 322 and 323 are present in relation to three environmental temperatures. In this case, using the three compensation values 321, 322 and 323, the compensation value interpolation unit 104 may calculate a curve 331 (relational expression) representing a relation between the environmental temperature and the compensation value by curve approximation. The compensation value interpolation unit 104 calculates a compensation value C2 at a specific environmental temperature (here, 25° C.) by using the curve 331.

The diagnosis data compensation unit 106 calculates, by using the compensation value interpolation unit 104, a compensation value at an environmental temperature corresponding to the diagnosis data stored in the diagnosis data storage unit 114. Then, the diagnosis data compensation unit 106 compensates the diagnosis data by using a similar method to the method in the normal data compensation unit 103.

Next, learning by the machine learning device 24 is described. The machine learning device 24 includes a learning model storage unit 241, a learning unit 242, and a machine abnormality determination unit 243. The learning unit 242 executes machine learning by using the feature of the compensated normal state data waveform calculated by the normal data compensation unit 103, and constructs a learning model. The constructed learning model is stored in the learning model storage unit 241, and is used for abnormality determination by the machine abnormality determination unit 243.

In the present embodiment, the machine learning device 24 executes abnormality determination by an MT method (Mahalanobis Taguchi method). Using the feature of the normal data compensated by the normal data compensation unit 103, the learning unit 242 provides a mathematical model below, by which the machine abnormality determination unit 243 executes abnormality determination, based on the degree of divergence from the normal data.

[Math. 1]

d=\sqrt{(x−μ)^{T}Σ⁻¹(x−μ)} (1)

wherein d is a Mahalanobis distance representative of a degree of divergence of the diagnosis data from the normal data; x is a vector in which features of diagnosis data waveforms compensated by the diagnosis data compensation unit 106 are arranged; μ is a vector in which average values of features of normal state data waveforms compensated by the normal data compensation unit 103 are arranged; and Σ is a variance-covariance matrix of features of normal state data waveforms compensation by the normal data compensation unit 103.

The learning unit 242 provides the mathematical model (learning model) expressed by the above equation (1) to the machine abnormality determination unit 243. The machine abnormality determination unit 243 calculates the degree of divergence from the normal data as the Mahalanobis distance d by the above equation (1) in regard to the feature x of the diagnosis data waveform compensated by the diagnosis data compensation unit 106. Then, when the Mahalanobis distance d calculated by equation (1) is greater than a preset threshold, the machine abnormality determination unit 243 determines that the diagnosis data is abnormal. The threshold used here may be set, for example, based on an experimental value or an empirical value. Such a configuration may be adopted that a user can set the threshold for the abnormality determination device 10.

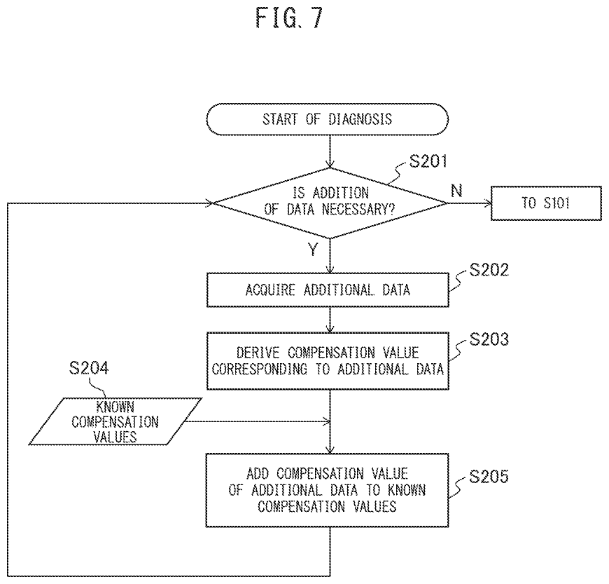

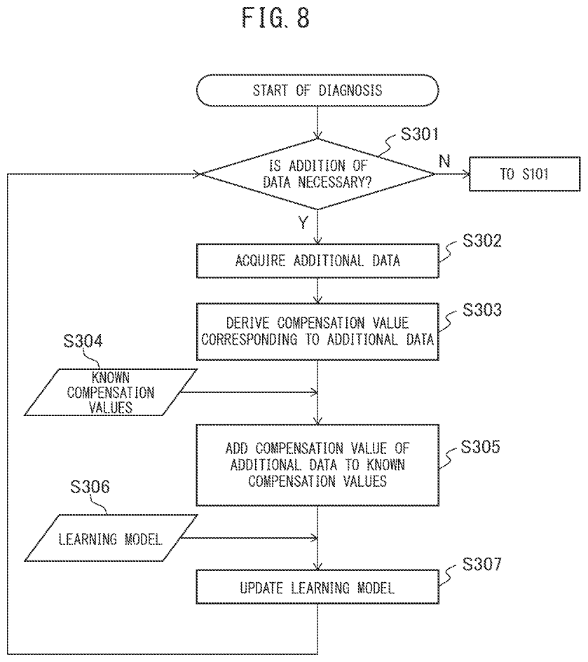

Hereinafter, embodiments of the abnormality determination device 10 are described. It is assumed that the learning model is already constructed by the learning unit 242. FIG. 6 is a flowchart representing a diagnosis process of a first embodiment. The diagnosis process of FIG. 6 (and FIG. 7 and FIG. 8) is executed under the control by the CPU 1 of the abnormality determination device 10. In the first embodiment, it is assumed that the known compensation values that are necessary for the interpolation of the compensation value are already derived by the compensation value deriving unit 105. To start with, state data for diagnosis (diagnosis data) is acquired via the state data acquisition unit 102 (step S101). Next, for a subsequent step, compensation values already calculated by the compensation value deriving unit 105 are taken in (step S102).

Next, by the above-described interpolation operation, the compensation value interpolation unit 104 calculates a compensation value in regard to the environmental temperature at the time when the diagnosis data is obtained (step S103). Furthermore, at this time, the diagnosis data compensation unit 106 compensates the diagnosis data by using the compensation value relating to the diagnosis data, which is acquired by the interpolation operation of the compensation value interpolation unit 104 (step S103). Next, the machine abnormality determination unit 243 calls the learning model (i.e. the above equation (1)) already constructed by the learning unit 242 (step S104). Subsequently, the machine abnormality determination unit 243 calculates the degree of divergence of the diagnosis data from the learning model, and determines normality/abnormality of the diagnosis data by comparing the degree of divergence with a predetermined threshold (step S105).

FIG. 7 is a flowchart representing a diagnosis process of a second embodiment. To start with, the abnormality determination device 10 (compensation value interpolation unit 104) determines whether acquisition of additional data is necessary. The additional data is indicative of state data at normal time, which can be acquired after the start of the main operation of the machine 50. For example, in the state in which the interpolation operation cannot be executed by the presently already acquired state data, the acquisition of additional data is determined to be necessary (step S201). When the acquisition of additional data is unnecessary (S201: NO), the diagnosis process of the above-described steps 5101 to 5104 is executed.

When the acquisition of additional data is necessary (S201: YES), the abnormality determination device 10 acquires additional state data (additional data) for learning from the machine 50 (step S202). A compensation value corresponding to the additional data is derived by the compensation value deriving unit 105 (step S203). Known compensation values necessary for the update of the compensation values (the update of the relational expression) are taken in (step S204). Then, update is executed to add the compensation value corresponding to the additional data to the known compensation values that are taken in. A set of the thus updated compensation values is prepared (step S205).

The process returns to step S201, and when the acquisition of further additional data is unnecessary (S201: NO), the diagnosis process by the above-described steps S101 to S105 is executed. In the diagnosis process of steps S101 to S105, the compensation value prepared in step S205 is applied (step S205, S102).

FIG. 8 is a flowchart representing a diagnosis process of a third embodiment. To start with, the abnormality determination device 10 (compensation value interpolation unit 104) determines whether acquisition of additional data is necessary. For example, in the state in which the interpolation operation cannot be executed by the presently already acquired state data, the acquisition of additional data is determined to be necessary (step S301). When the acquisition of additional data is necessary (S301: YES), the abnormality determination device 10 acquires additional state data (additional data) for learning from the machine 50 (step S302). A compensation value corresponding to the additional data is derived by the compensation value deriving unit 105 (step S303). Known compensation values necessary for the update of the compensation values (the update of the relational expression) are taken in (step S304).

Then, update of the compensation values is executed to add the compensation value corresponding to the additional data to the known compensation values that are taken in. A set of the thus updated compensation values is prepared (step S305). The learning unit 242 calls the trained learning model (step S306). The learning unit 242 executes re-learning by adding the additional data to the already acquired state data, and reconstructs the learning model (update of the learning model) (step S307). The process returns to step S301, and whether the acquisition of additional data is necessary is determined once again (step S301).

When the acquisition of additional data is unnecessary (S301: NO), the diagnosis process by the above-described steps S101 to S105 is executed. In the diagnosis process of steps S101 to S105, the new compensation value and new learning model updated in steps S305 and S307 are applied (step S305, S307, S102, S104).

The diagnosis process illustrated in FIG. 7 and FIG. 8 corresponds to a process in which the acquisition of state data (additional data) by the state data acquisition unit is continuously executed, and when the acquisition of additional data becomes unnecessary, the compensation value interpolation unit 104 updates the relational expression and utilizes the updated relational expression. In a modification of this process, the compensation value interpolation unit 104 may update the relational expression when the compensation value interpolation becomes possible, or when the number of additional data reaches a specified number, or when the degree of change of the environmental temperature exceeds a specified value (when the environmental temperature has sharply changed).

As described above, according to the present embodiment, exact diagnosis can be executed by calculating the compensation value from the normal data in accordance with the environmental temperature, and compensating the state data. In addition, by calculating, by interpolation, a compensation value at an unknown environmental temperature from known compensation values, compensation becomes possible in regard to the environmental temperature at which normal data could not be acquired in advance.

The present invention has been described above by using typical embodiments. It can be understood, however, that a person skilled in the art can make changes, various other modifications, omissions and additions to the above-described embodiments, without departing from the scope of the present invention.

In the above embodiments, the example was described in which the torque command waveform is used as the data relating to the state of the machine, but this is merely an example. As the data indicative of the state of the machine, use can be made of various data, such as data of various sensors, various data (velocity, acceleration, and the like) relating to the input and output of the electric motor, and the like.

In the above embodiments, the example was described in which the MT method is used as the machine learning, but methods other than the MT method may be used as methods for evaluating the degree of divergence of the diagnosis data from the normal data. For example, when both the data at normal time and the data at abnormal time are sufficiently acquired as the data relating to the state of the machine, a learning model may be constructed by applying supervised learning in the machine learning device, and the abnormality determination may be executed by using the learning model.

In the above embodiments, the abnormality determination device 10 is configured to acquire the state data from the machine 50. Instead of this configuration, the abnormality determination device may be configured to acquire the state data from the input device such as a keyboard, or from an external computer.

The functional blocks of the abnormality determination device 10 illustrated in FIG. 2 may be implemented by the execution of various kinds of software stored in a storage device by the CPU 1 of the abnormality determination device 10, or may be implemented by a configuration constituted mainly by hardware such as an ASIC (Application Specific Integrated Circuit).

A program for executing the diagnosis process (FIG. 6 to FIG. 8) in the above embodiments can be stored in various computer-readable storage media (for example, a semiconductor memory such as a ROM, an EEPROM or a flash memory, a magnetic storage medium, or an optical disc such as a CD-ROM or a DVD ROM).

### REFERENCE SIGNS LIST

1 CPU
2 ROM
3 RAM
4 Nonvolatile memory
10 Abnormality determination device
21 Display device
22 Input device
24 Machine learning device
50 Machine
101 Environmental temperature acquisition unit
102 State data acquisition unit
103 Normal data compensation unit
104 Compensation value interpolation unit
105 Compensation value deriving unit
106 Diagnosis data compensation unit
113 Normal data storage unit
114 Diagnosis data storage unit
241 Learning model storage unit
242 Learning unit
243 Machine abnormality determination unit

1. An abnormality determination device that determines abnormality of a machine, comprising:
a normal data storage unit configured to correlate and store normal data that is data relating to a state of the machine at a time when the machine normally operates, and an environmental temperature of the machine at a time when the normal data is acquired;
a diagnosis data storage unit configured to correlate and store diagnosis data that is data relating to the state of the machine at a time of diagnosing the machine, and the environmental temperature of the machine at a time when the diagnosis data is acquired;
a compensation value deriving unit configured to calculate a predetermined feature at each of the environmental temperatures in regard to the normal data stored in the normal data storage unit, and derive a statistical quantity obtained from the calculated feature at each of the environmental temperatures, as a compensation value at each of the environmental temperatures;
a compensation value interpolation unit configured to calculate, by interpolation, the compensation value in regard to the environmental temperature at a time when the diagnosis data is acquired, by using the compensation values in regard to at least two environmental temperatures with respect to which the normal data is included in the normal data storage unit;
a normal data compensation unit configured to compensate the feature of the normal data by using the compensation value at each of the environmental temperatures;
a learning unit configured to construct a learning model by performing learning by using the feature of the compensated normal data as training data at a normal time;
a diagnosis data compensation unit configured to compensate the feature of the diagnosis data by using the compensation value calculated by the compensation value interpolation unit; and
a machine abnormality determination unit configured to determine whether the diagnosis data is normal, based on a degree of divergence between the feature of the compensated diagnosis data and the learning model.

2. The abnormality determination device according to claim 1, wherein the compensation value interpolation unit calculates a relational expression representing a relation between the environmental temperature and the compensation value, and executes the interpolation by using the relational expression.

3. The abnormality determination device according to claim 2, further comprising:
a state data acquisition unit configured to acquire the data relating to the state of the machine from the machine; and
an environmental temperature acquisition unit configured to acquire the environmental temperature of the machine, wherein
the normal data storage unit correlates and stores the data relating to the state of the machine, which is acquired by the state data acquisition unit, and the environmental temperature at a time when the data is acquired.

4. The abnormality determination device according to claim 3, wherein when the compensation value interpolation unit is unable to derive the relational expression from the normal data that is stored in advance in the normal data storage unit before a main operation of the machine, the compensation value interpolation unit derives the relational expression by using as additional data the data acquired by the state data acquisition unit after the main operation.

5. The abnormality determination device according to claim 3, wherein the compensation value interpolation unit updates the relational expression calculated from the normal data that is stored in advance in the normal data storage unit before a main operation of the machine, by using as additional data the data acquired by the state data acquisition unit after the main operation of the machine.

6. The abnormality determination device according to claim 5, wherein
the state data acquisition unit continuously acquires the normal data after the main operation of the machine, and
the compensation value interpolation unit updates the relational expression when the number of additional data reaches a specified number.

7. The abnormality determination device according to claim 5, wherein
the state data acquisition unit continuously acquires the normal data after the main operation of the machine, and
the compensation value interpolation unit updates the relational expression when a degree of change of the environmental temperature exceeds a specified value.

8. The abnormality determination device according to claim 3, wherein the learning unit updates the learning model obtained based on the normal data that is stored in advance in the normal data storage unit before a main operation of the machine, by using as additional data the normal data acquired by the state data acquisition unit after the main operation of the machine and compensated by the normal data compensation unit.

9. The abnormality determination device according to claim 1, wherein the machine is a machine including an electric motor, and
the data relating to the state of the machine is a waveform of a torque command of the electric motor.
